(19) United States
(12) Patent Application Publication
(10) Pub. No.: US 2014/0314733 A1
(43) Pub. Date: Oct. 23, 2014

(54) Product and Method for the Removal of Biofilms

(71) Applicants: Gauthier Boels, Bruxelles (BE); Gordon Blackman, Lasnes (BE); Sébastien Fastrez, Mons (BE)

(72) Inventors: Gauthier Boels, Bruxelles (BE); Gordon Blackman, Lasnes (BE); Sébastien Fastrez, Mons (BE)

(73) Assignee: S.A. Realco, Louvain-la-Neuve (BE)

(21) Appl. No.: 13/866,733

(22) Filed: Apr. 19, 2013

(51) Int. Cl. C11D 3/386; A01N 63/00; A01N 59/02; A01N 37/02; A01N 59/00

(52) U.S. Cl. CPC C11D 3/38609; A01N 37/02; A01N 59/00; A01N 59/02; A01N 63/00
USPC 424/94.4; 510/392; 510/161; 435/264; 424/94.5; 424/94.61

(57) ABSTRACT

Composition for the removal of biofilms present on a substrate, comprising at least one detergent component comprising at least one sequestering agent and at least one agent that is simultaneously a wetting and a dispersing agent, and at least one enzymatic component containing at least one protease, at least one laccase and at least one polysaccharidase

The invention relates to the field of the elimination of biofilms. More particularly, the invention relates to a composition and to a method for removing biofilms.

Hygiene is of increasing importance in the food industry, in hospitals, particularly in the surgical sphere, in water purifying and water desalinization, in the water treatment process, and especially in water used in cooling towers and the necessities of life, such as contact lenses. It is frequently observed that, when water flows on a medium, microorganisms circulating freely in the water may adhere to the surface. These microorganisms can then develop an adhesive extracellular matrix composed by polymeric substances. A community of microorganisms, adhered to a surface and enclosed within such a matrix, is called a biofilm. Generally these biofilms are composed of bacteria.

Unfortunately, it is observed that this matrix is very resistant, and can be a barrier for agents, which could act against microorganisms. Conventional treatments with soda and/or with different biocides are not acting effectively enough because they do not penetrate the entire thickness of the biofilm or are inhibited by certain molecules composing the matrix. Then, the treatment is effective only partially on the top surface of the biofilm. In addition, this latter may also trap other microorganisms, including pathogens, other than the ones initially installed.

It is known, from the document WO98/26807, an enzymatic treatment method of a biofilm. In this process, the biofilm is contacted with a cleaning composition comprising one or more hydrolases for removing or releasing the biofilm layer from the surface. In a second step the biofilm is contacted with a bactericidal disinfecting composition to kill the bacterial cells present within the biofilm. However, the simultaneous use of these two compositions is at the origin of an inactivation degree of certain enzymes in the final mixture. The rapidity and the efficiency of the cleaning can then be improved by using a composition where the inactivation of enzymes is absent.

It is also known, from the document US2003/0205247, the use of aqueous solutions containing enzymes for cleaning storage tanks or fermentation tanks, containing one or more enzymes selected from the following: laccases, peroxidases, oxidoreductases, transferases, isomerases, lyases and ligases and a thickening agent with an amplifier of foam. The field of action of the above solutions is relatively narrow, specific to brewery, since the selected and illustrated enzymes are particularly known to be active on polyphenols which are mainly fermentation residues, tannins and the like. The thickening agent is a agent that modifies the viscosity and the thixotropy of the solution used in order to allow a better adherence of the solution and/or of the foam on the surface to be treated in tanks. These solutions are not suitable for cleaning installations other than tanks or reservoirs (including, for example, many tubes) and are therefore not suitable for the removal of other types of microorganisms and for a wide range of biofilms.

The document WO92/13807 discloses the use of a composition for the removal of the biomass and biofilm on substrates in aqueous systems; that is to say in systems where the water is circulated or stored. This type of system suffers from the presence of biomass and from the presence of alkaline or acidic biofilm due to the type of organisms generally present in this type of installation.

To solve this problem, the document WO 92/13807 teaches for the use of polysaccharidases and/or proteases and of anionic surfactants such as SDS or DBS (respectively sodium dodecyl sulfate and dodecylbenzenesulfonate) for the elimination of biomass and biofilms.

Unfortunately, this type of composition will not be effective for a wide range of biofilms caused by various microorganisms and will present a limited effectiveness in removing biofilms.

As it can be seen from the foregoing, these compositions are still targeted for one type of biofilm or targeted for a targeted microorganism and/or for a particular application.

There is therefore a need for a composition and a method capable of removing biofilms, which are effective within a reasonable time, acting on a broad class of biofilms produced by a large class of microorganisms or groups of microorganisms, which are not harmful to the support of the biofilm, and act to prevent the development of biofilms but also on biofilms formed long ago and having reached an important stage of cohesion and resistance.

To solve this problem, the present invention provides a composition for the removal of biofilms present on a substrate comprising:
at least one detergent component comprising at least one sequestering agent and at least one agent that is simultaneously a wetting and a dispersing agent,
at least one enzymatic component containing at least one protease, at least one laccase and at least one polysaccharidase.

The elaboration of a composition comprising a detergent component and an enzymatic component containing at least one protease, at least one laccase and at least one polysaccharidase allows, surprisingly, to improve significantly the rapidity and the efficiency of the removal of a biofilm while being able to attack various types of biofilms. This composition allows eliminating all or almost all the totality of the biofilm and can act on the same mature biofilms or on biofilms having an earlier development cycle and developed by multiple species or by different microorganisms.

So far, no effective composition ensures complete removal of biofilms in facilities. For example, in the field of food industry, biofilms are formed inevitably (because of the richness of the surrounding environment). Biofilms present cyclical growth activity comprising a growth phase during which the accumulation of microorganisms occurs and a phase of detachment during which pieces of biofilms are detached by erosion and under the effect of their own weight. When a manufacturer is faced with this phenomenon, he should actually stop the production line and perform various alternating washing cycles with soda, and with many detergents and/or chemical cleaners and/or enzymatic cleaners since there is no polyvalent composition. But this represents many hours of work and loss of efficiency of the installation.

Therefore, in practice, the production is not stopped and, when the biofilm is in the process of breaking, product batches are contaminated and discarded until the level of contamination by microorganisms in food products are acceptable according to the standards in force. In addition, it is not feasible for industrial to stock a detergent or an enzymatic solution for each microorganism that may possibly contaminate its production chain.

It is therefore very surprising that the present invention enables the provision of a perfectly polyvalent detergent composition which eliminates a broad spectrum of biofilms in various types of installations without requiring special precautions to employment. The detergent removes a superficial portion of the biofilm and wets and swells the organic structures of the biofilm thanks to the dispersing and the wetting characters of the agent that is simultaneously a wetting and a dispersing agent present in the detergent component. This therefore supports the accessibility of the enzymatic component that weakens and degrades the biofilm matrix. This associated action of the three types of enzyme and of the detergent component promotes the composition accessibility to deeper layers and allows optimal removal of any type of biofilm while preserving the substrate.

This type of agent that is simultaneously a welling and a dispersing agent also reduces the supply of external compounds in installations during the cleaning step and thus simplifies the validation procedures of cleaning steps.

In a particular embodiment of the invention, the composition is an aqueous cleaning solution having a pH comprised between about 8 and 11, preferably comprised between approximately 9.5 and 10.5 and more preferably comprised between approximately 9.5 and 10. The pH value of said composition significantly influences its efficiency on biofilms. A solution of said composition having a pH comprised approximately between 8 and 11 thus allows to eliminate, surprisingly, all or almost all the totality of the biofilm.

Alternatively, said composition may be under solid form and can then be dissolved in a solvent before use in order to obtain, by dilution in an aqueous phase, a cleaning solution having a pH comprised between approximately 8 and 11.

In an advantageous variant of the invention, the composition is a liquid solution which is then diluted in an aqueous phase to obtain an aqueous cleaning solution having a pH comprised between 6.5 and 7.5, more particularly a pH around 7. In this way, the pH of the composition is particularly suitable for the action of the enzymatic component, especially for the action of the laccase. Further, it is provided, according to the invention, to increase the pH, in a subsequent step of applying the composition according to the invention, in order to obtain a particularly suitable alkaline pH for the removal of the biofilm as mentioned above while keeping the optimum effectiveness of the enzymatic component.

Alternatively said composition may be under solid form and can then be dissolved in a solvent before use, before being diluted in an aqueous phase to obtain a cleaning solution having a pH comprised between approximately 6.5 and 7.5.

Preferably, said at least one enzymatic component comprises a proportion of protease(s) comprised between 10 and 50%, a proportion of laccase(s) comprised between 5 and 35% and a proportion of polysaccharidase(s) comprised between 5 and 20% by weight with respect to the weight of the enzymatic component, an excipient or a conventional solvent being optionally added to reach 100%, for example an alcohol.

According to a preferred embodiment of the invention, the enzyme component can contain between 1 and 10 proteases, preferably between 1 and 5 proteases, more preferably may contain 2, 3, 4 or 5 proteases.

Non-limiting examples of protease enzymes belonging to the class EC 3.4 is susceptible to be used in the invention are aminopeptidases (EC 3.4.11), dipeptidases (EC 3.4.13), dipeptidylpeptidases and tripeptidylpeptidases (EC 3.4.14), peptidyldipeptidases (EC 3.4.15), serine carboxypeptidases (EC 3.4.16), mettalocarboxypeptidases (EC 3.4.17), cysteine carboxypeptidases (EC 3.4.18), omega peptidases (EC 3.4.19), serine endopeptidases (EC 3.4.21), cysteine endopeptidases (EC 3.4.22), aspartic endopeptidases (EC 3.4.23), metalloendopeptidases (EC 3.4.24), threonine endopeptidases (EC 3.4.25) and endopeptidases belonging to the class EC 3.4.99.

Preferably, proteases belong to the class EC 3.4.21. Proteases are commercially available and under different forms including powders, pellets, suspensions, liquid solutions.

Laccases used in the invention belong to the class EC 1.10.3.2. Laccases are enzymes containing copper and have the function of oxidizing a substrate in presence of oxygen. More specifically, laccases are oxidoreductases which work with molecular oxygen as electron acceptors.

The at least one polysaccharidase used in the invention is an enzyme having the function of breaking links within the polysaccharides. Preferably, the at least one polysaccharidase can be an alpha-amylase, cellulose, hemi-cellulase, glucosidase, beta-glucanase or pectinase.

More preferably, the at least one polysaccharidase can be an alpha-amylase belonging to the class EC 3.2.1.1, having the function of breaking (1-4)-alpha-glycosidic links in polysaccharides containing three units or more alpha-(1-4)-D-glucose.

Preferably, the enzymatic component may comprise a proportion of laccase(s) of approximately 30%, a proportion of protease(s) of approximately 30%, a proportion in alpha-amylase(s) of approximately 10% by weight with respect to the weight of the enzymatic component, an excipient or a conventional solvent being eventually added to reach 100% by weight of the enzymatic component.

According to another preferred embodiment, if the enzymatic component comprises 2 proteases, the proportion of laccase(s) can be of approximately 30%, the total proportion of proteases of approximately 30%, the proportion of alpha-amylase(s) of approximately 10% by weight with respect to the weight of the enzymatic component, an excipient or a conventional solvent being eventually added to reach 100% by weight of the enzymatic component.

According to another preferred embodiment, if the enzymatic component comprises 2 proteases, the proportion of laccase can be of 30%, the total proportion of proteases of 30%, the proportion of alpha-amylase(s) of 10% by weight with respect to the weight of the enzymatic component, an excipient or a conventional solvent being eventually added to reach 100% by weight of the enzymatic component.

For example, the ratio between each proteases can be comprised between 1:2 and 2:1, preferably the ratio between each proteases can be of 1:1. The enzymes present in the enzymatic component have a complementary action on the biofilm. For example, the laccase has a high efficiency on the contamination which is not attacked by the alpha-amylase or proteases.

According to a preferred embodiment of the invention, the enzymatic component can be a solution or under solid form.

Preferably, the enzymatic component is a solution with a pH that can be comprised between 8 and 10. Preferably, the enzymatic component is an aqueous solution with a pH that can be comprised between 8.5 and 9.5; more preferably the pH can approximately be of 9.0.

Alternatively, the enzymatic component can be under solid form as for example under lyophilizate, powders, pellets or under any other form enabling the solubilization of said component in a solvent, then it will subsequently be dissolved in a solvent. The solvent can be water or an aqueous solution, acid, alcoholic, basic, buffer or neutral. The solubilized enzymatic component could be, in this case, subsequently diluted in an aqueous solution eventually containing one or several compounds as for example, detergents to form the cleaning solution.

In an advantageous embodiment according to the invention, said at least a detergent component comprises a proportion of sequestering agent comprised between 1 and 10% by weight with respect to the total weight of the detergent agent, what represents an optimum of efficiency, stability and cost.

The sequestering agent is a chemical substance having the capacity to form complexes with mineral ions that it fixes under a form preventing their precipitation by the usual reactions. For example, the sequestering agent can be the ethylene diamine tetra acetic acid, glucono-delta-lactone, sodium gluconate, potassium gluconate, calcium gluconate, citric add, phosphoric add, tartaric add, sodium acetate, sorbitol, a compound comprising an atom of phosphorus. Preferentially, the sequestering agent can be a phosphorus oxide as phosphanate, or a phosphate or their mixture, or a salt thereof, an amine or an amine oxide having at least, in its structure, a functional group of phosphine, phosphine oxide, phosphinite, phosphonite, phosphite, phosphonate, phosphinate or phosphate, alone or in combination, or a salt thereof.

More preferentially, the sequestering agent can be a phosphonate or a salt thereof, an amine or an amine oxide comprising at least, in its structure, a functional group of phosphine, phosphine oxide, phosphinite, phosphonite, phosphite, phosphonate, phosphinate or phosphate, alone or in combination or a salt thereof. As a non limiting example, the phosphonate can be of the general formula R¹(R²O)(R³O)P═O in which R¹, R² and R³ represent independently a hydrogen, alkyl, substituted alkyl, substituted alkyl amino group or unsubstituted alkyl amino group, substituted aminoalkyl group or unsubstituted aminoalkyl group, aryl or substituted aryl group. As for non limiting example, the amine or amine oxide can comprise one, two or three substituent(s) with the general formula CR⁴R⁵W in which R⁴ and R⁵ represent independently one of the other hydrogen, alkyl, substituted alkyl, substituted alkyl amino or unsubstituted alkyl amino group, substituted aminoalkyl or unsubstituted aminoalkyl group, aryl or substituted aryl group, and W represents a phosphonate, phosphinate or phosphate group. The sequestering agent can be under the form of a salt of sodium, calcium, lithium, magnesium or potassium; preferably, the sequestering agent can be under the form of a salt of sodium, calcium or potassium.

In an advantageous embodiment of the invention, the proportion of agent that is simultaneously a wetting and a dispersing agent is comprised between 15 and 50% by weight with respect to the total weight of the detergent component, preferably between 20 to 30%, what represents a compromise between efficiency, stability and cost.

An agent that is simultaneously a wetting and a dispersing agent is an amphiphilic chemical substance, which modify the superficial tension between two surfaces having the advantage to promote the spreading of a liquid on a solid (anionic, cationic, non-ionic or zwitterionic) while presenting a dispersant character meaning that is being the capability to improve the separation of particles of suspension in order to prevent agglutination, aggregation and/or decantation.

Advantageously, said agent that is simultaneously a wetting and a dispersing agent is selected from the group consisting of non-foaming wetting agents at high temperature and preferably comprises a C6-C10 alkylglucoside, preferably a C8 alkylglucoside, obtained from renewable raw materials and optionally an ethoxylated alcohol.

The wetting and dispersing agent is preferably a preparation comprising an ethoxylated alcohol and an alkylpolyglucoside (in particular, an octyl glucoside) coming from renewable raw materials. As it can be seen, this agent that is simultaneously a wetting and a dispersing agent enables performances of surfactant and emulsion particularly high without destabilized enzymes present in the composition according to the invention since this agent that is simultaneously a wetting and a dispersing agent is an anionic agent having a low net global charge in order to not interfere with the exchange of ions between enzymes and substrates of these latter. The agents that are simultaneously wetting and dispersing agents obtained from renewable raw materials are particularly appropriate and act synergistically with the enzymes by avoiding their destabilization with respect to the usual surfactants from crude oil origin (with longer carbonated chain). Moreover, according to the invention, the agent that is simultaneously a wetting and a dispersing agent can be anionic, cationic or non-ionic, but in any case, it will present a low net ionic global charge in order to be compatible and not destabilized the enzymes.

Moreover, the agent that is simultaneously a wetting and a dispersing agent according to the invention comprising an ethoxylated alcohol and an alkylpolyglucoside is particularly polyvalent in that it is compatible with a wide range of pH, with the presence of several acids or bases and builders, while being non-foaming at high temperature.

The fact that the agent that is simultaneously a wetting and a dispersing agent is a non-foaming wetting agent at high temperature allows a polyvalent use, either in tanks and surfaces or in systems with many pipes and tubes, thereby avoiding the formation of foam, without altering, on the contrary the surfactant and/or emulsifying performances of the composition according to the invention. In addition, as already mentioned above, the presence of an agent that is simultaneously a wetting and a dispersing agent limits the supply of polymeric substances in the installations, for example, in installations for circulating or treating water. It is understood that the supply of an effective detergent solution without generating foam limit rinsing steps, which is highly desirable, especially in systems with multiple tubes or pipes.

The invention also relates to a method for the removal of biofilms present on a substrate comprising the following steps:
a) providing of a detergent component containing at least one sequestering agent and at least one agent that is simultaneously a wetting and a dispersing agent and of one enzymatic component containing at least one protease, at least one laccase and at least one polysaccharidase,
b) dilution of the detergent component in an aqueous phase,
c) dilution of the enzymatic component in the solution formed in step b) to form the solution of said composition according to the invention, or
   b′) dilution of the enzymatic component in an aqueous phase,
   c′) dilution of the detergent component in the solution formed in step b′) to form the solution of said composition according to the invention,
d) application of the solution of said formed composition in step c) or c′) on the substrate during a predetermined period of time, in particular comprised between 15 minutes and 4 hours.
   The term “dilution”, according to the present invention, means a formal dilution of a solid compound in a liquid phase or a dilution of a liquid compound in a liquid phase in which the liquid compound is miscible.

Alternatively, steps b) and c) or b′) and c′) can be carried out simultaneously to form a solution of said composition according to the invention.

Preferably, the method comprises the following steps:
a) providing a detergent component containing a sequestering agent, a wetting agent and a dispersing agent; and an enzymatic component comprising at least one protease, at least one laccase, and at least a polysaccharidase,
b) dilution of the detergent component in the water,
c) dissolution of the enzyme component in the solution formed in step b) to form the solution of said composition according to the invention,
d) application of the solution of said composition formed in step c) on the substrate during a predetermined period of time, preferably between 15 minutes and 4 hours.

Advantageously, the pH of the solution of said composition formed in step c) or c′) is comprised between 8 and 11, preferably comprised between approximately 9.5 and 10.5 and more preferably between 9.5 and 10.

According to a preferred embodiment of the invention, the pH of the solution formed in step b) is approximately comprised between 11.0 and 14.0, preferably approximately comprised between 12.0 and 14.0, and more preferably comprised between 12.8 and 13.8.

In a particular embodiment according to the invention, the pH of the solution of said composition formed at stage c) or c′) is comprised between 6.5 and 7.5 and a basic solution is added after said application d) of the solution of said composition on said substrate during said predetermined period of time, in order to perform a pH jump up to approximately 8 to 9.

In this way, when said composition according to the invention is applied on said substrate, the ruling pH is comprised between 6.5 and 7.5, which allows the laccase to be in optimal conditions for an accurate activity. Then, by effecting a pH jump up to about 8 to 9, it allows the other enzymes to reach their optimal activities, as well. In this way, they will also reach their optimal activities, and it results that said biofilm will be removed in a particularly advantageous way since each enzyme will get the optimal conditions for acting on the biofilm, said biofilm will be expected to be completely removed and detached. Further, as basic components are usually used in installations wherein biofilms may be formed, there is no addition of exogenous compounds that could be problematic for the validation of the cleaning step. For instance, for cleaning an installation, it is common to use limey. In the scope of the present invention, the step of bringing substances with a nature that is different remains limited.

Preferably, temperature of the solution of detergent component formed during application b) or c′) may be comprised between about 35° C. and 50° C.

In a particular embodiment according to the invention, said composition according to the invention is applied on a substrate coated by a biofilm for about 30 to 50 minutes, which represents an application time quite short for such an efficiency.

Preferably, the detergent component comprises a proportion of sequestering agent comprised between 1 and 10%, a proportion of an agent that is a simultaneously a wetting and a dispersing agent comprised between 15 and 50% by weight, 100% of the total weight being eventually reached by adding a conventional excipient such as water.

Preferably, said at least one enzymatic component comprises a proportion of protease(s) comprised between 10 and 50%, a proportion of laccase(s) comprised between 5 and 35% and a proportion of polysaccharidase(s) comprised between 5 and 20% by weight with respect to the weight of the enzymatic component, an excipient or a conventional solvent such as alcohol being optionally added to reach 100%.

More preferably, said at least one polysaccharidase comprises an alpha-amylase.

Said method allows to efficiently entirely or quasi-entirely remove said biofilm, leaving only few isolated cells without the matrix protection. The subsequent action of a biocide allows to destroy the microbial strain. A subsequent disinfecting phase will therefore be much more efficient after having applied a solution of the composition according to the invention, rather than a conventional cleaning phase that does not avow a total removal of said matrix.

Therefore, according to a particular embodiment according to the invention, said method further comprises a subsequent step of applying a biocide agent. For instance, biocides may be, in a non limiting way, of oxidant type such as peracetic acid, hydrogen peroxide, potassium monopersulphate, sodium hypochlorite. According to the invention, the application of a biocide must be subsequent to the application of said composition according to the invention in order to avoid a biocide induced desactivation of the enzymes included in said composition.

The invention also relates to a use of a composition according to the invention for the removal of biofilms present on a substrate, in particular for the cleaning of soils and surfaces, for the cleaning in place or for soaking. Said composition can be used for closed facilities or by soaking. In particular, cleaning by soaking is performed for cleaning surgical equipment and contact lens. Said composition is also used for cleaning of technical and process water circuit systems, air-conditioning exchanger systems as well as in food industry.

The present invention also relates to a kit for removing biofilms on a substrate comprising:
at least one sample of a detergent component in solution or under its solid form comprising at least one first sequestering agent and at least one agent that is simultaneously a wetting and a dispersing agent,
at least one sample of an enzymatic component in solution or under its solid form containing at least one protease, at least one laccase and at least one polysaccharidase.

Preferably, said at least one polysaccharidase is an alpha-amylase.

In a particularly preferred embodiment, according to the invention, said sample of said enzymatic component contains between 1 and 10 proteases, preferably between 1 and 5 proteases, more preferably may contains 2, 3, 4, or 5 proteases.

In another particularly preferred embodiment according to the invention, said sample of said enzymatic component contained in said kit may comprise 2 proteases. Preferably, if said enzymatic component contains 2 proteases, proportion of laccase may be of approximately 30%, the total proportion of proteases may be of approximately 30%, the proportion of alpha-amylase may be of approximately 10% by weight, with respect to the total weight of said sample of said enzymatic component, an excipient or conventional solvent being added to said sample in order to reach 100% of the weight of said enzymatic component.

Preferably, if the sample of said enzymatic component comprises 2 proteases, the proportion of laccase(s) may be of 30%, the total proportion of proteases may be of 30%, the proportion of alpha-amylase(s) may be of 10% by weight. For instance, the ratio between each protease can be included between 1:2 and 2:1, preferably between the ratio between each protease may be of 1:1.

If said sample of said enzymatic component contained in said kit is an aqueous solution, the pH of said aqueous solution is comprised between 8 and 10, preferably, said pH may be comprised between 8.5 and 9.5, more preferably said pH may be of about 9.0.

Preferably, the sample of the detergent component comprises a proportion of sequestering agent comprised approximately between 1 and 10%, a proportion of an agent that is simultaneously a wetting and a dispersing agent of 15 to 50% by weight, with respect to the total weight of said detergent component, 100% of the total weight being eventually reached by adding a conventional excipient such as water.

As an example, said sequestering agent may be ethylene-diamine-tetra-acetic acid, glucono-delta-lactone, sodium gluconate, potassium gluconate, calcium gluconate, citric acid, phosphoric acid, tartaric add, sodium acetate, sorbitol, a compound comprising a phosphor atom. Preferably, said sequestering agent may be a phosphorus oxide such as phosphonate, phosphinate, or phosphate, or a salt thereof, an amine or an amine oxide, or a salt thereof, said salt carrying at least in its structure a phosphine, phosphine oxide, phosphinite, phosphonite, phosphate, phosphonate, phosphinate or phosphate functional group.

More preferably, said sequestering agent may be a phosphonate or its salt, an amine or an amine oxide, or a salt thereof, said salt carrying at least in its structure a phosphine, phosphine oxide, phosphinite, phosphonite, phosphate, phosphonate, phosphinate or phosphate functional group. As a not restrictive example, said phosphonate may be of R¹(R²O)(R³O)P═O general formula wherein R¹, R² and R³ are independently selected among the group of hydrogen, alkyl, substituted alkyl, aminoalkyl substituted or not, aryl or substituted aryl. As a not restrictive example, said amine or said amine oxide may comprise one, two, or three substituent(s) of general formula: CR⁴R⁵W wherein R⁴ and R⁵ are independently selected among the group consisting of hydrogen, alkyl, substituted alkyl, aminoalkyl substituted or not, aryl or substituted aryl, and W is selected among the group consisting of phosphonate, phosphinate, or phosphate. Said sequestering agent may be a salt of sodium, calcium, lithium, magnesium, or potassium; preferably, said sequestering agent may be a salt of sodium, calcium, or potassium.

Advantageously, said agent that is simultaneously a wetting and a dispersing agent is chosen in the group consisting of non-foaming wetting agents at high temperature and preferably comprises a C6 to C10 alkylglucoside, preferably a C8 alkylglucoside, from renewable raw materials, and optionally a ethoxy alcohol.

Said agent that is simultaneously a wetting and a dispersing agent is preferably a preparation comprising ethoxyl alcohol and an alkylpolyglucoside (in particular an octyl glucoside) from renewable raw materials.

As it can be seen, said agent that is simultaneously a wetting and a dispersing agent allows particularly high surfactant as well as high emulsifying performances without destabilising the enzymes in the composition according to the invention as said agent that is simultaneously a wetting and a dispersing agent is an anionic agent presenting a weak global net charge so that said agent does not interfere with ions exchanges occurring between enzymes and substrates of the latter. Said agents that are simultaneously wetting and dispersing agents from renewable raw materials are particularly appropriate and synergistically act with said enzymes whilst not destabilizing them, compared to usual surfactants from oil industry (presenting longer carbon carbon chains). Further, according to the present invention, said agent that is simultaneously a wetting and a dispersing agent may be anionic, cationic, or non ionic, but, in any case, it will present a global net charge that is weak so that it is compatible and does not destabilise enzymes.

Moreover, said agent that is simultaneously a wetting and a dispersing agent according to the invention comprising an ethoxyl alcohol and an alkylpolyglucoside is particularly polyvalent in that it is compatible with a large panel of pH values, with the presence of many bases or acids and of builders, whilst being non-foaming at high temperature.

Advantageously, in said kit according to the invention, said sample of enzymatic component is an aqueous solution with a pH comprised between 8 and 10.

If said sample of detergent component is a solution, pH of said solution is comprised between 8.5 and 14.0.

If said cleaning solution obtained from dilution of said detergent and enzymatic components in an aqueous phase has a pH ranging between 6.5 and 7.5, then said detergent component, if it is a solution, will have a pH comprised between 9 and 10.

Solubilisation in aqueous phase of the two components, for instance thanks to the presence of buffers in one or another component or due to the dilution effect, will lead to a decrease of the pH of the cleaning solution so that said pH is optimal to ensure laccases operating accurately.

If the cleaning solution resulting from dilution of said detergent component and said enzymatic component in an aqueous phase must have a pH of about 10, therefore said detergent component, if it is in the form of a solution, will present a pH preferably comprised between 12.0 and 14.0, more preferably between 12.8 and 13.8. Solubilisation in said aqueous phase of said two components will lead the pH of the cleaning solution to reach values of about 9.5 to 10.5. To this end, components may for instance further contain alkaline compounds.

Preferably, said kit further comprises a biocide agent.

Other characteristics and advantages of the invention will appear more clearly in the light of the following description of a particular non-limiting embodiment of the invention, while referring to the figures and to the examples.

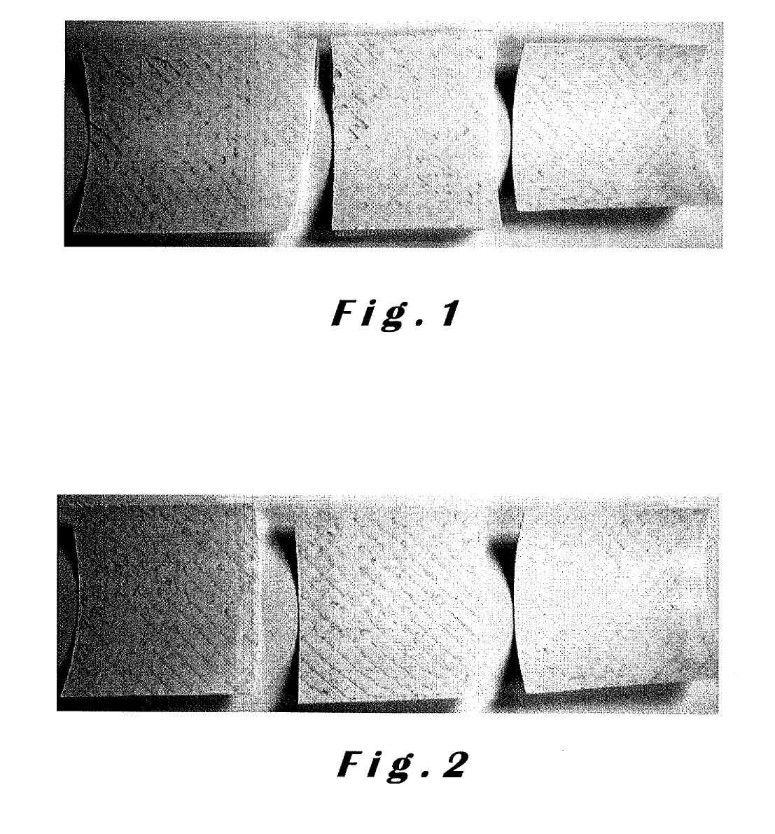

FIG. 1 depicts results from test comparing the efficiency of the composition according to the invention with respect to those obtained with lye.

FIG. 2 depicts results from test comparing the efficiency of the composition according to the invention with respect to those obtained with other detergent components.

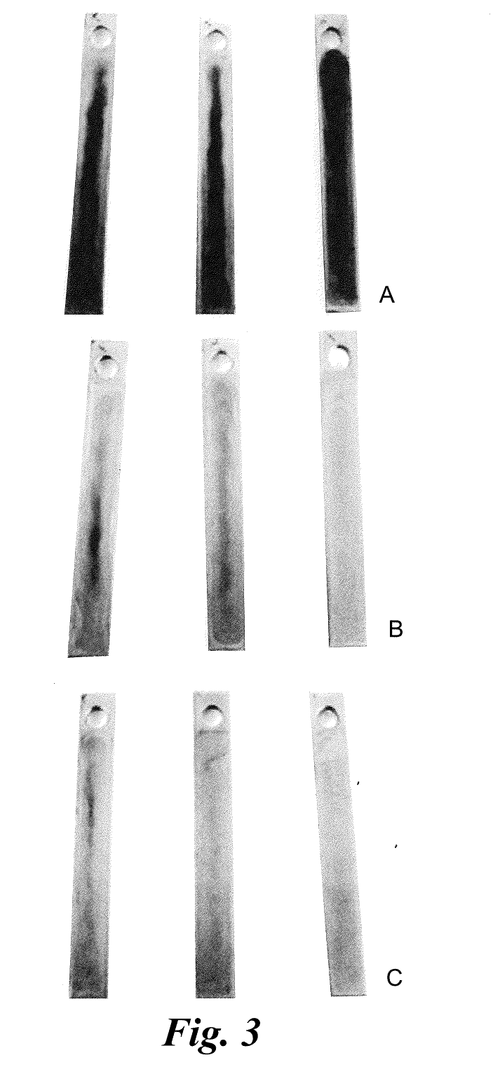

FIG. 3 depicts results from test comparing the efficiency of the composition according to the invention with respect to those obtained with other detergent components and by effecting a pH jump.

Other characteristics and advantages of the invention will appear more clearly in the light of the following description of a particular non-limiting embodiment of the invention, while referring to the figures and to the examples.

### EXAMPLE 1

A trial for comparing the efficiency of the composition according to the invention with respect to a rinsing with water and NaOH has been conducted. Biofilms are developed on osmosis membranes used in desalinations installations. A bacterian inoculum (Pseudomonas aeruginosa) is prepared by culturing during 16 hours in a TSB 10% (tryptone soy broth) medium. This pre-culture is diluted in order to obtain an optical density (OD) of 0.05 at 600 nm and 500 μl of said solution has been spread on each membrane. Samples are incubated for 48 hours in petri dishes kept wet and placed in an oven at 30° C. After 2 hours, the bacterial solution is replaced by 500 μl of fresh medium, TSB 10%. After 24 hours, this medium is renewed.

Said samples are then cleaned and placed in said cleaning solutions. The membranes are soaked in said cleaning solutions during 120 minutes at 200 rpm and 35° C.

Cleaning solutions are the followings:
1. Water;
2. Liquid NaOH, 0.5%;
3. Composition according to the invention at pH 7.

TABLE 1

| | Solution 1 | Solution 2 | Solution 3 |
|---|---|---|---|
| Visual | Dirt ridging are | About 50% of | Most of the dirt |
| appearance of | still apparent on | the dirt | on the |
| the membrane | the membrane | disappeared | membrane |
| | | | surface has |
| | | | disappeared |

These results are also depicted in FIG. 1 that illustrates from the left to the right said membrane after being treated by water, by liquid NaOH and by said composition according to the invention at pH 7.

As we can see, only the composition according to the invention leads to a substantial removal of said biofilm.

### EXAMPLE 2

A trial for comparing the efficiency of the composition according to the invention with respect to other detergent compositions has been conducted. This trial has been conducted following a process similar to the one of example 1, except for the cleaning solutions that are:

1. A composition containing 3 different agents, i.e., a sequestering agent, a wetting agent, and a dispersing agent, plus a enzymatic component containing at least one laccase, one protease and one polysaccharidase.

2. A composition containing two different agents, i.e., a sequestering agent and an agent that is simultaneously a wetting and a dispersing agent, plus an enzymatic component similar to the one of point 1. at pH=7.

3. A composition containing two different agents, i.e., a sequestering agent and an agent that is simultaneously a wetting and a dispersing agent, plus an enzymatic component similar to the one of point 1. at pH=10.

TABLE 2

| | Solution 1 | Solution 2 | Solution 3 |
|---|---|---|---|
| Visual | Some dirt ridging | Almost all of the | Most of the dirt |
| appearance of | are still apparent | dirt on the | on the |
| the membrane | on the | membrane | membrane |
| | membrane (25% | surface has | surface has |
| | with respect to | disappeared | disappeared |
| | the visual aspect | | |
| | before cleaning) | | |

These results are also depicted in FIG. 2 that illustrates from the left to the right said membrane after being treated by said solution 1, solution 2, and solution 3.

As we can see, only the composition according to the invention at pH 7 or 10 leads to a substantial removal of said biofilm.

### EXAMPLE 3

Steel remnants have been treated by a composition similar to composition 1 of example 2 and by a composition according to the invention initially at pH=7 and by effecting a pH jump up to a value equal to 10 after 15 minutes following the below-mentioned protocol.

Biofilms have been developed on stainless steel remnants previously washed and sterilized. An inoculum bacteria (Pseudomonas aeruginosa) is prepared by culturing during 16 hours in a TSB 10% (tryptone soy broth) medium. This pre-culture is diluted in order to obtain an optical density (OD) of 0.05 at 600 nm and 500 μl of said solution has been spread on each membrane. Samples are incubated for 48 hours in petri dishes kept wet and placed in an oven at 30° C. After 2 hours, the bacterial solution is replaced by 500 μl of fresh medium, TSB 10%. After 24 hours, this medium is renewed.

Then, said remnants have been placed in test tubes containing 10 ml of a TSB+0.5% Tween 80 solution for bacteria count. The test tubes have been let for incubation during 5 minutes on the working table before being sonicated during 2 minutes 30 seconds and then vortexed for 30 seconds. Said steps of incubating, sonicating, and vortexing being repeated.

The remnants have then been collected and said TSB+0.5% medium has been serially diluted by using peptone water (indole free peptone water: to prepare 10 ml of a 15 g/I dissolution followed by a step of diluting 1 ml of said solution in 1 l of sterile water) and has been spread on a petri dish and incubated at 30° C. for a night before counting.

The bioflim has also been coloured in the following manner: said remnants are drained and put for 10 minutes into the proteins selective colouring solution, said proteins coming from the biofilm matrix.

Remnants are then put in the different cleaning solutions 1 and 2. mentioned hereunder twice for ten minutes (said cleaning solution are replaced between said two steps of cleaning), and are then dried at open air.

Cleaning Compositions:

1. A composition containing 3 different agents, i.e., a sequestering agent, a wetting agent, and a dispersing agent, plus a enzymatic component containing at least one laccase, one protease and one polysaccharidase.

2. A composition containing two different agents, i.e., a sequestering agent and an agent that is simultaneously a wetting and a dispersing agent, plus an enzymatic component similar to the one of point 1. at pH=7.

Results:

In one petri dish on 3 (4/12) corresponding to remnants cleaned with composition 1, bacteria grew up (average>10⁹ CFU).

Bacteria did not grow up in petri dishes cleaned with the composition according to the invention.

FIG. 3 depicts results from biofilms coloration. FIG. 3A depicts the references remnants before cleaning while FIG. 3B depicts steel remnants after cleaning with solution 1. at different pH, FIG. 3C depicts steel remnants after cleaning with composition according to the invention.

As we can see, only the remnants cleaned with the composition according to the invention have a cleaner aspect than those cleaned with composition 1 and do not present bacteria on their surface while biofilm is detected for ⅓ of the remnants cleaned with composition 1.

Other characteristics and advantages of the invention will appear more clearly in the light of the following description of a particular non-limiting embodiment of the invention, while referring to the figures and examples,

We claim:

1. A composition for the removal of biofilms present on a substrate comprising:
at least one detergent component comprising at least one sequestering agent, and at least one agent that is simultaneously a wetting and a dispersing agent; and
at least one enzymatic component containing at least one protease, at least one laccase, and at least one polysaccharidase.

2. Composition according to claim 1, wherein the composition is a solution having a pH comprised between about 8 and 11.

3. Composition according to claim 1, wherein the composition is a solution having a pH comprised between 6.5 and 7.5, more particularly about 7.

4. Composition according to claim 1, wherein said at least one enzymatic component comprises a proportion of protease(s) comprised between 10 and 50%, a proportion of laccase(s) comprised between 5 and 35% and a proportion of polysaccharidase(s) comprised between 5 and 20% by weight with respect to the weight of the enzymatic component, an excipient or a conventional solvent being optionally added to reach 100%.

5. Composition according to claim 1, wherein said at least one polysaccharidase comprises an alpha-amylase.

6. Composition according to claim 1, wherein said at least one detergent component comprises a proportion of sequestering agent comprised between 1 and 10% by weight with respect to the total weight of the detergent component.

7. Composition according to claim 1, comprising a proportion of agent that is simultaneously a wetting and a dispersing agent comprised between 15 and 50% by weight with respect to the total weight of the detergent component.

8. Composition according to claim 1, wherein said agent that is simultaneously a wetting and a dispersing agent is selected from the group consisting of non-foaming wetting at high temperature and preferably comprises a C6-C10 alkylglucoside.

9. Method for the removal of biofilms present on a substrate comprising the following steps:
a) providing of a detergent component containing at least one sequestering agent and at least one agent that is simultaneously a wetting and a dispersing agent and of one enzymatic component containing at least one protease, at least one laccase, and at least one polysaccharidase;
b) dilution of the detergent component in an aqueous phase;
c) dilution of the enzymatic component in the solution formed in step b) to form the solution of said composition according to claim 1; or
b′) dilution of the enzymatic component in an aqueous phase;
c′) dilution of the detergent component in the solution formed in step b′) to form the solution of said composition according to claim 1;
d) application of the solution of said formed composition in step c) or c′) on the substrate during a predetermined period of time, in particular comprised between 15 minutes and 4 hours.

10. Method according to claim 9, further comprising a subsequent step of applying a biocide on the substrate.

11. Method according to claim 9, wherein the pH of the solution of said composition is comprised between 8 and 11.

12. Method according to claim 9, wherein the pH of the solution of said composition is comprised between 6.5 and 7.5 and wherein a basic solution is added after said application d) of the solution of said composition on said substrate during said predetermined period of time, in order to perform a pH jump up to approximately 8 to 9.

13. Use of a composition according to claim 1 for the removal of biofilms on a substrate.

14. Use according to claim 13, of a composition according to claim 1 for the cleaning of floors and surfaces, for the cleaning in place or for soaking.

15. Use according to claim 14, wherein said cleaning by soaking is used for cleaning surgical equipment.

16. Kit for removing biofilms on a substrate comprising:
at least one sample of a detergent component in solution or under its solid form comprising at least one first sequestering agent and at least one agent that is simultaneously a wetting and a dispersing agent; and
at least one sample of an enzymatic component in solution or under its solid form containing at least one protease, at least one laccase and at least one polysaccharidase.

17. Kit according to claim 16, wherein the sample of the enzymatic component is an aqueous solution with a pH comprised between 8 and 10.

18. Kit according to claim 16, wherein the sample of the detergent component is an aqueous solution with pH comprised between 8.5 and 14.

19. Kit according to claim 16, further comprising a biocide agent.
